(19) United States
(12) Patent Application Publication
(10) Pub. No.: US 2008/0179025 A1
(43) Pub. Date: Jul. 31, 2008

(54) PROCESS FOR SOFTENING HYGIENIC PAPER

(76) Inventors: Stefano Carrara, Dalmine (BG) (IT); Marco Granelli, Bergamo (IT); Dario Cavalli, Milano (IT)

Correspondence Address: HENKEL CORPORATION, 1001 TROUT BROOK CROSSING, ROCKY HILL, CT, 06067, US

(21) Appl. No.: 11/959,754

(22) Filed: Dec. 19, 2007

Related U.S. Application Data
(63) Continuation of application No. PCT/EP2005/006960, filed on Jun. 29, 2005.

(51) Int. Cl. D21H 23/22; B31F 1/07

(52) U.S. Cl. 162/109

(57) ABSTRACT

An on-line process for manufacturing a multi-ply hygienic paper product is provided which involves the steps of supplying at least two separate webs to a processing station, applying to at least one of the surfaces of a web forming an outer ply a softening composition, adjoining the webs by gluing and/or embossing to manufacture a multi-ply hygienic paper product and directly transporting such paper to a cutting and/ or further processing station.

### CROSS-REFERENCE TO RELATED APPLICATIONS

This application is a continuation under 35 U.S.C. § 365(c) and 35 U.S.C. § 120 of international application PCT/EP2005/006960, filed 29 Jun. 2005, and published 4 Feb. 2007 in English as WO 2007/000177, which is incorporated herein by reference in its entirety.

### FIELD OF THE INVENTION

The invention relates to a process for producing multi-layer hygiene paper and hygiene tissues from various generally web-shaped starting materials forming the individual layers of the finished products, whereby the starting materials are supplied from material supply stations and continuously processed whereby an additional process step for an application of a softening composition to such multi-layer paper is included in the process. The invention relates also to the multi-layer products manufactured by such process.

### DISCUSSION OF THE RELATED ART

Methods and apparatus for the manufacture of multi-ply tissues and papers are known in the art and are used for producing facial tissues, bath tissues, hygiene pads, liners, hygiene paper and the like. Such modern hygiene products of this type generally comprise several layers that are connected together in a sandwiched or multi-ply structure. For this purpose it is typical to supply narrow webs or bands of various starting materials from large supply rolls to the actual processing stations in which the starting materials are processed in a suitable manner to form the finished products.

Such hygiene products are frequently applied and come into contact with the skin. During frequent use, the skin may be compromised and can become so abraded that it might become red and sore to the touch. Additionally the feeling of the surface may be hard and stiff but it should provide a soft feeling. In order to address these concerns, there have been numerous previous attempts to reduce the abrasive effect of such tissues and to increase their softness. One common approach to increase the softness of hygiene products is by closely controlling the mechanical processing of the paper web. By using particular processing steps during papermaking such paper or tissue products can be made that are softer and less irritating. Besides mechanical processing, other patents describe the use of emollients, lubricants and cleansing agents and the like to such products to enhance the softness impression and to reduce irritation on the skin. To add such wet additives during the paper making process raises the problem of wet strength stability of the web.

US 2003/0059579 describes a sanitary paper tissue product consisting of several plies. On the outer surfaces a chemical softening composition containing polysiloxan-polyalkyleneoxide copolymer is applied. This application is performed during the paper making process, which means after the web has been prepared and dried and is still warm from this process the softening solution is applied and thereafter the web is wound on rolls.

WO 03/027390 describes a soft tissue paper product which comprises on the outer surface of that tissue a chemical softening composition comprising a polysiloxan-copolymer. This softening agent is applied during the web making process after the web has been dried and thereafter this web is wound on rolls.

U.S. Pat. No. 6,551,691 describes an absorbent paper product consisting of several plies. These plies are glued together and are subjected to an embossing step. The embossed plies may contain a softening agent but no specific description of this softening agent is made.

This prior art always includes the application of the softening agent in the web making process either to the wet web or to the dry web. Thereafter the rolls of web are stored and transported to the tissue making companies and at that stage the different layers are bound together and the multi-ply product is made. It is a disadvantage that already during the paper making process the different softeners need to be applied. This means that on a later stage in the plant making the multi-ply products no change or adaptation to a different softening agent is possible. So the process is less flexible. Additionally, during rolling and transport of the paper rolls the soft surface is frequently damaged and the later manufactured products do not show adequate surface softness as provided originally to the single web after manufacture.

### BRIEF SUMMARY OF THE INVENTION

The present invention therefore provides a process to manufacture multi-ply paper products whereby during the manufacture and preparation of a web as precursor material no addition of a softening composition or a softening step is required. The soft feel character shall be applied to the ready made product during the processing step of manufacturing the multi-ply paper product out of the single webs.

The problem is solved by a process for manufacturing a multi-ply hygiene paper product comprising supplying at least two separate web materials to a processing station, applying to at least one of the surfaces of the webs forming an outer ply a softening composition, adjoining the web layers by glueing and/or embossing to manufacture a multi-ply hygiene paper and transporting such product to a cutting and/ or further processing station.

### DETAILED DESCRIPTION OF CERTAIN EMBODIMENTS OF THE INVENTION

The substrates for manufacturing multi-ply paper products are known. They consist of webs of different size. The single webs to be adjoined may consist of various natural fibers pre-ferably obtained from wood pulp but other cellulosic fibrous pulp fibers such as cotton, linters, bagasse, etc. can be utilized. Also, synthetic fibers may be used such as polyethylene, polypropylene or polyamide fibers, also a combination of synthetic and natural fibers is possible. The obtained product shall form a paper or tissue web.

The present invention is useful with tissue paper and hygiene paper in general, such paper or tissue products according to the invention are always multi-ply materials of at least two webs. The webs may consist of conventionally pressed paper, densified paper or uncompacted paper. During the papermaking process, various chemicals may be added to the fiber materials, e.g. for improving wet strength, lubricants and other common additives to be selected according to the specific use of the product. Such additives applied during the paper making or web making process are known in the prior art. After the web is completed and dried it is wound to rolls which may be stored.

An apparatus for manufacturing multi-ply paper products is generally known. It comprises a plurality of processing stations as well as a plurality of supply stations. The supply stations feed web-shaped starting materials, which shall form the individual layers and parts of the finished paper product. The starting material is stored on supply rolls which are transported from the supply stations to the processing stations where the different webs are processed to form the finished multi-ply product.

More particularly, the processing stations may include printing stations, embossing and/or stamping stations as well as a cutting station for respectively embossing or stamping and cutting the material in the process of manufacturing the paper product. Additionally at least one adhesive applicator device for applying glue or other adhesives onto the webs forming the multi-ply products is present. The apparatus further includes transport arrangements for transporting on-line the materials through the processing stations, including web guidance arrangement for guiding the web among the respective processing stations. According to the invention at least one applicator device for the application of a softener composition is included, which shall coat at least one surface with a softener composition.

The web-shaped starting material is initially supplied and stored in a condition rolled-up on supply rolls in the supply stations. From there, the web-shaped starting material runs from the supply rolls through a material web store, which may have any conventional construction and operation. The process according to the invention shall proceed continuously, so a respective web end splicer device may be arranged after the supply roll.

According to the process the different webs used in the multi-ply product may be identical or may consist of different materials.

An apparatus to be utilized according to the process shall include suitable transport and guide arrangements so that the web-shaped starting material can be rolled from the supply roll and then driven and deflected as necessary to be supplied from the supply roll to the processing stations.

Optionally, a printing station can be integrated in the apparatus as a first processing station. The web which shall constitute the outer surface of the multi-ply product may be printed. Such printing stations are known and can be easily integrated in this process. Only one printing station for one surface may be integrated but it is also possible to imprint both outer layers of the product. As the printing ink may influence the surface of the web, this process step shall be performed prior to any softening step.

After the printing step and optionally after embossing the web but preferably prior to the embossing station a softening composition is applied to at least one web of the multi-ply product. Such softening compositions are liquid products which may be applied by known devices to a web. This application may be performed by rolls, printing devices, nozzles or spray application. This can be performed to one web or in a parallel process step to two or more webs of the multi-ply product. The at least one web to be treated shall constitute an outer layer of the multi-ply product. Preferably the surface of the web to be treated with the softening composition shall constitute the outer surface of the finished multi-ply paper product. Alternatively it may be possible to apply the softening composition to the inner surface of such web. In such case the softener will be absorbed by the web and may migrate through the web to affect the other surface of such web. It is required for the process according to the invention that at least one outer surface shall show the soft feel effect. In one embodiment of the invention a softening agent is applied to only one of the outer web layers, another embodiment includes the application of such softening composition to both of the outer web layers.

The softener composition shall provide to the outer layers of the tissue or hygiene paper a soft feel effect. The amount of the softening composition applied in this process is between 1 to 10 g/m², preferably 2 to 7 g/m², of the surface (wet composition).

Such application of a softening composition may be performed on different steps of the process due to the parallel processing of the webs to be adjoined. If only one outer web is subject to an embossing step the application of the softening composition may be performed directly after such embossing step. In such case it is possible not to coat the complete surface of the web with a softening composition, but only the upper parts of the embossed surface. In another embodiment of the invention the softener composition is applied directly after the printing step to one or more webs prior to adjoining the webs. In another embodiment of the invention the softening composition is applied to an outer web and to a different web an adhesive or glue is applied. Subsequently as the next step of each process the different webs are adjoined together. In each case the softening composition according to the invention shall be composed of a waterborne material. It is not required to add a drying step before further processing the web. The additional moisture applied to the paper through the softening composition may be absorbed and distributed in the web without deteriorating the mechanical properties of the webs.

After application of the softening composition to at least one web the different webs shall be adjoined. This can be performed either by embossing the webs together, gluing the webs together or by a combination of gluing and embossing the different webs together. For example, as next step in the manufacturing process the webs may be subjected to an embossing step.

Conventional rotary embossing stations may be used to emboss the webs. Typical embossing stations may include rotary embossing rolls and cooperating, rotary anvil rolls. The embossing rolls have been configured to provide an array of embossing dies to provide embossing lines arranged with selected shapes. Other conventional embossing stations have also included bonding components for providing construction bonds. In particular systems, the construction bonds have been located proximate the regions of the web where the web has been embossed. Typically, the operating speed of the embossing system will be limited by the available embossing force and by the amount of dwell time needed to reliably form the desired embossments. Preferably the embossing operation will be performed prior to a cutting operation that separates the multi-layer web into individual articles.

The embossing shall be accomplished while substantially avoiding undesired breaks or fractures of component portions of the web. It is known to add friction-reducing material to the web or a debonding agent. This may not be necessary when applying the softening composition prior to the embossing step, or the softening composition may include such ingredients. The moisture content of the cellulosic fibers shall be controlled during the embossing process to support the embossing process without any interruption of the continuous process. To adjust to a suitable moisture content, the amount of the softening composition to be applied or water content may be adjusted.

After the application of the softening composition or preferably parallel to embossing the web or instead of the embossing step an additional process step for the application of a glue or an adhesive to the different webs may be included in the process. Such adhesive shall provide a good adhesion between the different layers of the multi-ply product. Material and devices for the application of a glue or an adhesive to paper webs are already known. The adhesive may be applied to each single layer of the multi-ply product, it may be applied only to each second layer of the product or it may be applied to only one layer in the multi ply product, so that only a part of the layers are glued together. It is possible to apply such adhesive to the outer layer of the multi-layer product or preferably it may be applied to the layer adjacent to the outer layer of the multi-ply product. It is preferred not to apply the adhesive to the surface which has already been coated with the softening composition and if possible to select a different web.

The adhesives may be applied over the whole surface of the web, in a variety of patterns on a surface, connecting at least portions of the adjacent surface of one layer with portions of the adjacent surface of the next layer, or it may be applied in form of signs, logos, letters and the like to a surface. In such case the adhesive may be colored.

Any operative adhesive applicator may be employed. Suitable applicators can include adhesive spray devices, adhesive coating devices, adhesive printing devices, or the like, as well as combinations thereof. Any operative adhesive may be employed. For example, suitable adhesives can include hot melt adhesives, pressure-sensitive adhesives, solvent-based adhesives or waterborne adhesives. Preferably such adhesives are hot melt adhesives. Such hot melt adhesives can contain polymers based on polyesters, polyurethanes, polyamides, polyacrylates or polyolefins. Another embodiment of the invention applies waterborne adhesives to the webs. Examples of such adhesives are described in EP 1085973. The adhesive may contain dyes or pigments, so that its printing patterns may be visible and may serve as printing step. The adhesives may be applied to the surface as a continuous film or in a certain pattern. Additionally it is possible to apply the coating only on the upper part of an embossed web so that only such upper parts are glued to the adjacent web surface. Such application technology and the respective devices for the application are generally known.

According to the invention, to improve the soft feel effect of the multi-ply paper a softening composition has to be applied to at least one outer surface of the multi-ply paper. Such softening compositions are already known. Preferably a waterborne softening composition may be used in a process according to this invention. Such softening composition shall include a softening agent, water and other useful ingredients like conditioners, surfactants, organic solvents, builders, bleaching agents, complexing agents, perfumes, dyes, biological active compounds, stabilizers and other components. The softening compositions used for the present invention may additionally comprise lubricants, a structurant or rheology enhancer like thickeners.

As softening agent most preferably quaternary ammonium compounds, cationic polymers or cationic surfactants are preferred. Quaternary ammonium compounds are commonly known under the name of esterquat. Cationic polymers may include for example polyquaternary polymers like grafted cellulose derivates, cationic cellulose derivates, cationic quaternary sugar derivates and/or amino silicon copolymers.

Other non-ionic softening agents may be included in the composition additionally. Examples of such components are polyoxyalkylene-glycerolalcanoate, polybutylene, long chain fatty acids, ethoxylated fatty acidamides, alcylpolyglycosides or fatty acid esters of polycarboxylic acids. The softening composition may contain one or more of such softening components, preferably in an amount of 3 to 35% by weight of the total composition.

In order to enhance the application process and the properties of the multi-ply product, additional ingredients can be incorporated into the softener composition. The classes of ingredients and their corresponding benefits include, without limitation: antifoaming agents, preservatives, antimicrobial actives, antiseptic actives, antioxidants, astringents, biological additives, vitamins, botanical extracts, proteins, peptides, skin protectants, lipids, sterols; colorants, deodorants, fragrances, moisturizers, humectants, lubricants, such as silicones and organomodified silicones, skin protectants, UV absorbers, optical brighteners and waxes.

Another class of additives are components for regulating the viscosity, e.g., thickeners. Such additives include inorganic or organic components like natural polymers, like xanthane, agar-agar, cellulosic polymers or synthetic polymers, like (meth)acrylicacids, or silicates, like bentonite, montmorillonite, aluminium silicate. In combination with the solvents it is possible to adjust the viscosity of the softening composition according to the requirements of the application device. Additionally, a hydrophilic surfactant may be utilized to emulsify various ingredients into the formulation, and improve wettability of the product. Such additives shall be present in an amount from 0.1 to 10% of the composition.

Preferably a softening composition suitable for to the invention shall contain water. The amount of water may range between 20% to 90%, preferably between 40% to 80%. It may include additionally organic solvents in particular low molecular weight alcohols. Such alcohols include liquid polyethylenglycols with low molecular weight, e. g., with a molecular weight of 200 to 600 g/mol. Other useful solvents are alcohols like ethanol, isopropanol, n-propanol; ketones like acetone and methylethylketone; C₂ to C₆ polyols in particular diols or triols like ethylene glycol, propylene glycol, glycerin or mixtures thereof. The organic solvents may be included in an amount between 0.1% to 30%, in particular from 3% to 15%.

Waterborne softening compositions which may be used in the process of the invention are for example described in DE 1033976 or EP 1097270, which shall be specifically included in this application.

The application of the softening composition may be performed by known methods. Such methods include, for example, spraying, printing, coating, extrusion, ink jet printing, and combinations thereof. It should be applied in such a manner that the tissue does not become oversaturated with the softening formulation. If oversaturation occurs this may lead to a substantial decrease in the tensile strength of the web and poor aesthetic performance. After application of the softening composition, the web shall not contain too much humidity in order not to deteriorate the strength of the web during processing. When applied to the paper product, the softening compositions described herein shall impart a soft feel to the touch.

According to one embodiment of the invention, the paper webs constituting the outer layers are printed, coated with a softening composition, embossed and glued to other webs composing the other layers of the product. After the multi-ply product is formed the product is conveyed to a cutting station. Such cutting stations are generally known. They manufacture out of the web shaped multi-ply product the ready made form. This may include rolls of paper, folded paper, and the like. During each process step after the application of the softening composition the handling of the web shall be arranged to avoid additional strong pressing steps to the outer surface of such multi-ply product.

Another embodiment of the invention consists of a multi-ply paper or tissue product manufactured according to the process of this invention. It consists of at least two layers of paper or similar fibrous sheets, which at least on one outer side of the surface show a soft feel effect. It may also contain several layers, preferably 3 to 5, which may consist of the same material or of different materials, having different mechanical performance. The multi-ply paper may show one imprinted and/or embossed outer surface but it is also possible to have two imprinted and/or embossed surfaces. The product shall be manufactured according to the process of the invention. The softening composition shall not be incorporated during the papermaking process, but shall be applied on-line during the adjoining step of the different layers.

The multi-ply product manufactured in a process according to the invention shows on at least one surface a soft feel effect. Such effect will be maintained during the preparation of the ready made product. The absorbed softening composition does not significantly deteriorate the embossing step and the gluing step, which means that the further processing of the single webs in the process is not impaired. Especially the speed of manufacture of the processing line is similar to the processing speed without the application step of the softening agent. So according to the invention a multi-ply product in form of paper or tissue product is manufactured by a process which shows an improved flexibility in the manufacture by changing the softening composition in the process so that different types of multi-ply paper may be manufactured. Additionally, according to the process of the invention the number of steps which may disturb the soft feel surface of the web is reduced as the softening agent may be applied at a very late production stage.

What is claimed is:

1. A process for manufacturing a multi-ply hygiene paper product comprising
a) supplying at least two separate webs to a processing station;
b) applying a softening composition to at least one of the surfaces of at least one of the webs that will form an outer ply of the multi-ply hygiene paper product;
c) applying to at least one web an adhesive layer;
d) adjoining the webs by embossing to form a multi-ply hygiene paper; and
e) transporting said multi-ply hygiene paper to a cutting and/ or further processing station.

2. A process according to claim 1, wherein the softening composition is applied to both of the webs that will form the outer plies of the multi-ply hygiene paper product.

3. A process according to claim 1, wherein the softening composition is applied to the surface of a web that will form an outer surface of the multi-ply hygiene paper product.

4. A process according to claim 1, wherein the softening agent is applied to both surfaces of the webs that will form the outer surfaces of the multi-ply hygiene paper product.

5. A process according to claim 1, wherein the softening composition is applied by a means selected from printing, spraying or rolling.

6. A process according to claim 1, wherein a waterborne adhesive or a hot melt adhesive is applied in step c).

7. A process according to claim 1, wherein one or more adhesive layers are applied in a manner so that every two adjacent webs are bonded by an adhesive layer.

8. A process according to claim 1, additionally comprising a printing step wherein a printing ink is applied to one web forming an outer ply prior to application of the softening composition or after application of the softening composition.

9. A process according to claim 1, wherein no supplemental drying step is performed on the at least one web after the application of the softening composition.

10. A process according to claim 1, wherein an additional drying step is performed on the least one web subsequent to the application of the softening composition.

11. A process according to claim 1, wherein the softening composition is a waterborne solution.

12. A process according to claim 11, wherein the softening composition is applied in an amount between 1 to 10 g/m² on each surface.

13. A process according to claim 11, wherein the softening composition is comprised of 3% to 35% by weight of one or more softening agents, 0.1% to 30% by weight of one or more low molecular weight alcohols, and 0.1% to 10% by weight of one or more additives.

14. A multi-ply hygiene paper product manufactured according to claim 1, comprising at least two plies wherein to at least one of the outer plies a waterborne softening composition is applied when manufacturing said multi-ply hygiene paper product.

15. A multi-ply hygiene paper product according to claim 14, wherein to an outer surface of at least one outer ply a waterborne softening composition is applied.

16. A multi-ply hygiene paper product according to claim 14, wherein to the outer surfaces of both outer plies a waterborne softening composition is applied.

17. A multi-ply hygiene paper product according to claim 14, comprising at least three plies.

18. A multi-ply hygiene paper product according to claim 14, wherein the softening composition is applied in an amount between 1 to 10 g/m² to said at least one of the surfaces of at least one of the webs that will form an outer ply of the multi-ply hygiene paper product.

19. A multi-ply hygiene paper product according to claim 14, wherein the softening composition is comprised of 3% to 35% by weight of one or more softening agents, 0.1% to 30% by weight of one or more low molecular weight alcohols, and 0.1% to 10% by weight of one or more additives.

20. A multi-ply hygiene paper product according to claim 14, wherein a waterborne adhesive or a hotmelt adhesive is used.
